(19) United States
(12) Patent Application Publication
(10) Pub. No.: US 2010/0211986 A1
(43) Pub. Date: Aug. 19, 2010

(54) Reception Apparatus, Reception Method, Program, and Communication System

(76) Inventor: Takatoshi ISOBE, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/699,587

(22) Filed: Feb. 3, 2010

(30) Foreign Application Priority Data
Feb. 19, 2009 (JP) P2009-036713

(51) Int. Cl. H04N 7/173; H04N 9/74

(52) U.S. Cl. 725/114; 348/581; 348/E09.055

(57) ABSTRACT

Provided is a reception apparatus receiving reception data including at least image data representing a predetermined image and graphic data representing a first graphic that is enlarged by a predetermined enlargement factor to be synthesized with the predetermined image, the reception apparatus including: an acquisition portion to acquire server access information for connecting to a delivery server that delivers high-quality graphic data representing, instead of the first graphic enlarged by the predetermined enlargement factor, a second graphic that is to be synthesized with the predetermined image and has a higher image quality than the enlarged first graphic; a reception portion to receive the high-quality graphic data from the delivery server based on the server access information; and a synthesis portion to synthesize the second graphic with the predetermined image based on the high-quality graphic data and the image data.

### BACKGROUND OF THE INVENTION

1. Field of the Invention

The present invention relates to a reception apparatus, a reception method, a program, and a communication system, in particular, to a reception apparatus, a reception method, a program, and a communication system that are capable of improving an image quality of characters and graphics drawn on a still image (moving image) that represents a received program and the like, for example.

2. Description of the Related Art

From the past, there exists a digital broadcast reception apparatus that receives a digital broadcast signal broadcasted by a digital terrestrial broadcast and the like and synthesizes, with a still image representing a program or the like included in the received digital broadcast signal, a character/graphic plane on which a character and a graphic specified by document data included in the received digital broadcast signal (document data described in program language such as BML (Broadcast Markup Language), that is broadcasted as so-called data broadcast) are drawn to output it.

Accordingly, it becomes possible to display, with a still image representing a program or the like as a background image, an image constituted of the character and the graphic specified by the document data broadcasted as the data broadcast on a display portion of the digital broadcast reception apparatus of the related art.

Incidentally, in a current broadcasting standard, a drawing plane on which characters and graphic are drawn for generating the character/graphic plane described above is specified to have a resolution of 960×540 (horizontal size×vertical size) pixels.

Therefore, in the digital broadcast reception apparatus of the related art, the character/graphic plane having a resolution of 960×540 pixels is generated by drawing characters and graphics on the drawing plane.

Thus, as shown in FIG. 1, in a case where a still image (moving image) representing a program or the like, that has a resolution of 1920×1080 pixels, is to be output to the display portion or the like in the digital broadcast reception apparatus of the related art, it has been necessary to enlarge the character/graphic plane having the resolution of 960×540 pixels to twice the size in a horizontal direction and a longitudinal direction to obtain a resolution of the still image representing a program or the like (1920×1080 pixels), synthesize the enlarged character/graphic plane with the still image representing a program or the like, and output it as a data broadcast output.

Therefore, since the character/graphic plane is enlarged to twice the size in both the horizontal and longitudinal directions in the digital broadcast reception apparatus of the related art, the characters and graphics drawn on the character/graphic plane are also enlarged to twice the size in the horizontal and longitudinal directions. As a result, looseness of characters and graphics drawn on the character/graphic plane or the like may be caused, to thus deteriorate an image quality of the characters and the graphics.

In this regard, there is proposed a drawing technique of preparing in advance a drawing plane having a resolution of 1920×1080 pixels and drawing characters of an appropriate size that corresponds to the resolution of 1920×1080 pixels on the drawing plane (see, for example, Japanese Patent Application Laid-open No. 2008-85614).

### SUMMARY OF THE INVENTION

However, a graphic subjected to a data compression using, for example, a PNG (Portable Network Graphics) method is assumed to be drawn on a drawing plane having a resolution of 960×540 pixels.

Therefore, in the drawing technique of the related art, for changing the graphic subjected to the data compression using the PNG method into a graphic for drawing on a drawing plane having a resolution of 1920×1080 pixels, it has been necessary to enlarge the graphic subjected to the data compression using the PNG method to twice the size in the horizontal and longitudinal directions and draw the enlarged graphic on the drawing plane having the resolution of 1920×1080 pixels.

In this case, as in the digital broadcast reception apparatus of the related art, looseness of the graphic drawn on the character/graphic plane has been caused to thus deteriorate the image quality of the graphic.

In view of the circumstances as described above, there is a need to additionally improve an image quality of a graphic drawn on a predetermined image included in a digital broadcast signal or the like.

According to an embodiment of the present invention, there is provided a reception apparatus receiving reception data including at least image data representing a predetermined image and graphic data representing a first graphic that is enlarged by a predetermined enlargement factor to be synthesized with the predetermined image, the reception apparatus including: an acquisition means for acquiring server access information for connecting to a delivery server that delivers high-quality graphic data representing, instead of the first graphic enlarged by the predetermined enlargement factor, a second graphic that is to be synthesized with the predetermined image and has a higher image quality than the enlarged first graphic; a reception means for receiving the high-quality graphic data from the delivery server based on the server access information; and a synthesis means for synthesizing the second graphic with the predetermined image based on the high-quality graphic data and the image data. Alternatively, there is provided a program causing a computer of a reception apparatus that receives reception data including at least image data representing a predetermined image and graphic data representing a first graphic that is enlarged by a predetermined enlargement factor to be synthesized with the predetermined image to function as: an acquisition means for acquiring server access information for connecting to a delivery server that delivers high-quality graphic data representing, instead of the first graphic enlarged by the predetermined enlargement factor, a second graphic that is to be synthesized with the predetermined image and has a higher image quality than the enlarged first graphic; a reception means for receiving the high-quality graphic data from the delivery server based on the server access information; and a synthesis means for synthesizing the second graphic with the predetermined image based on the high-quality graphic data and the image data.

The reception data may be a digital broadcast signal including the server access information in addition to the graphic data and the image data, and the acquisition means may acquire the server access information from the digital broadcast signal.

The synthesis means may synthesize, when the high-quality graphic data is not received by the reception means, the first graphic enlarged by the predetermined enlargement factor with the predetermined image based on the graphic data and the image data included in the digital broadcast signal.

The digital broadcast signal may also include character data representing a character to be synthesized with the predetermined image, and the synthesis means may additionally synthesize, with the predetermined image, the character of a size corresponding to the predetermined image based on the character data.

The acquisition means may acquire the server access information for connecting to the delivery server that delivers the high-quality graphic data representing the second graphic having a higher resolution than the enlarged first graphic.

The synthesis means may draw, based on the high-quality graphic data, the second graphic on a drawing plane to be synthesized with the predetermined image, and synthesize the drawing plane on which the second graphic has been drawn with the predetermined image.

According to an embodiment of the present invention, there is provided a reception method for a reception apparatus that receives reception data including at least image data representing a predetermined image and graphic data representing a first graphic that is enlarged by a predetermined enlargement factor to be synthesized with the predetermined image, the reception apparatus including an acquisition means, a reception means, and a synthesis means, the reception method including the steps of: acquiring, by the acquisition means, server access information for connecting to a delivery server that delivers high-quality graphic data representing, instead of the first graphic enlarged by the predetermined enlargement factor, a second graphic that is to be synthesized with the predetermined image and has a higher image quality than the enlarged first graphic; receiving, by the reception means, the high-quality graphic data from the delivery server based on the server access information; and synthesizing, by the synthesis means, the second graphic with the predetermined image based on the high-quality graphic data and the image data.

According to this embodiment, the server access information for connecting to the delivery server that delivers the high-quality graphic data representing, instead of the first graphic enlarged by the predetermined enlargement factor, the second graphic that is to be synthesized with the predetermined image and has a higher image quality than the enlarged first graphic is obtained, the high-quality graphic data is received from the delivery server based on the server access information, and the second graphic is synthesized with the predetermined image based on the high-quality graphic data and the image data.

According to an embodiment of the present invention, there is provided a communication system including: a reception apparatus to receive reception data including at least image data representing a predetermined image and graphic data representing a first graphic that is enlarged by a predetermined enlargement factor to be synthesized with the predetermined image; and a delivery server to deliver high-quality graphic data representing a second graphic that has a higher image quality than the first graphic enlarged by the predetermined enlargement factor in response to a request signal from the reception apparatus. The reception apparatus includes an acquisition means for acquiring server access information for connecting to the delivery server that delivers the high-quality graphic data representing, instead of the first graphic enlarged by the predetermined enlargement factor, the second graphic that is to be synthesized with the predetermined image and has a higher image quality than the enlarged first graphic, a first reception means for receiving the high-quality graphic data from the delivery server based on the server access information, and a synthesis means for synthesizing the second graphic with the predetermined image based on the high-quality graphic data and the image data. The delivery server includes a second reception means for receiving the request signal that requests transmission of the high-quality graphic data transmitted from the reception apparatus based on the server access information, and a transmission means for transmitting the high-quality graphic data to the reception apparatus based on the request signal.

According to this embodiment, the reception apparatus acquires the server access information for connecting to the delivery server that delivers the high-quality graphic data representing, instead of the first graphic enlarged by the predetermined enlargement factor, the second graphic that is to be synthesized with the predetermined image and has a higher image quality than the enlarged first graphic, receives the high-quality graphic data from the delivery server based on the server access information, and synthesizes the second graphic with the predetermined image based on the high-quality graphic data and the image data. Moreover, the delivery server receives the request signal requesting transmission of the high-quality graphic data, that is transmitted from the reception apparatus based on the server access information, and transmits the high-quality graphic data to the reception apparatus based on the request signal.

According to another embodiment of the present invention, there is provided a reception apparatus receiving reception data including at least image data representing a predetermined image and graphic data representing a first graphic that is enlarged by a predetermined enlargement factor to be synthesized with the predetermined image, the reception apparatus including: an acquisition portion to acquire server access information for connecting to a delivery server that delivers high-quality graphic data representing, instead of the first graphic enlarged by the predetermined enlargement factor, a second graphic that is to be synthesized with the predetermined image and has a higher image quality than the enlarged first graphic; a reception portion to receive the high-quality graphic data from the delivery server based on the server access information; and a synthesis portion to synthesize the second graphic with the predetermined image based on the high-quality graphic data and the image data.

According to another embodiment of the present invention, there is provided a program causing a computer of a reception apparatus that receives reception data including at least image data representing a predetermined image and graphic data representing a first graphic that is enlarged by a predetermined enlargement factor to be synthesized with the predetermined image to function as: an acquisition portion to acquire server access information for connecting to a delivery server that delivers high-quality graphic data representing, instead of the first graphic enlarged by the predetermined enlargement factor, a second graphic that is to be synthesized with the predetermined image and has a higher image quality than the enlarged first graphic; a reception portion to receive the high-quality graphic data from the delivery server based on the server access information; and a synthesis portion to synthesize the second graphic with the predetermined image based on the high-quality graphic data and the image data.

According to the embodiments of the present invention, it is possible to additionally improve an image quality of a graphic drawn on a predetermined image included in a digital broadcast signal or the like, for example.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a diagram for explaining a digital broadcast reception apparatus of the related art;

FIG. 2 is a diagram for explaining a general outline of the present invention;

FIG. 3 is a block diagram showing a structural example of a communication system;

FIG. 4 is a diagram showing an example of a syntax of a BIT describing URI information;

FIG. 5 is a block diagram showing a structural example of a digital broadcast reception apparatus;

FIG. 6 is a flowchart for explaining display control processing;

FIG. 7 is a flowchart for explaining first high-quality drawing processing; and

FIG. 8 is a flowchart for explaining second high-quality drawing processing.

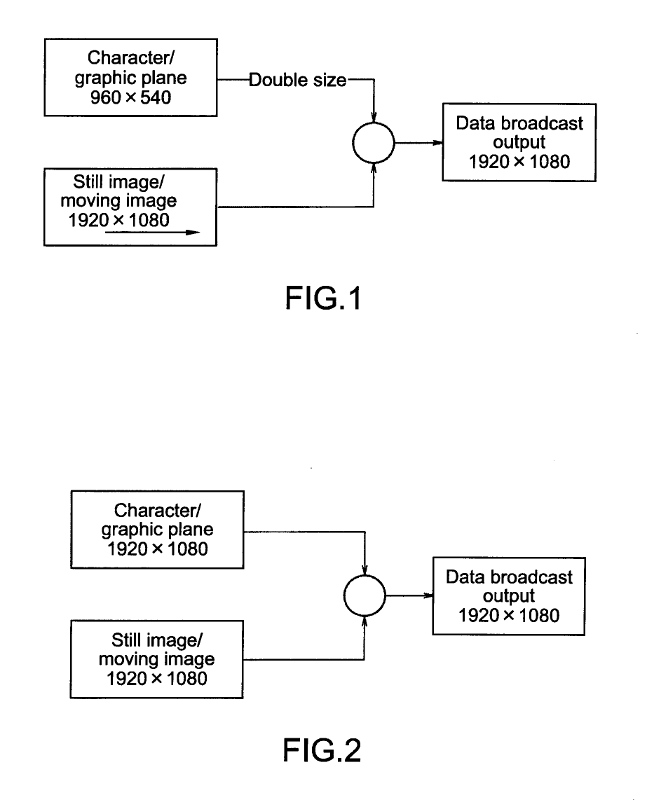

### DESCRIPTION OF PREFERRED EMBODIMENTS

Hereinafter, an embodiment of the present invention will be described with reference to the drawings.

### 1. Embodiment

2. Modified example

### 1. Embodiment

### General Overview of Embodiment

First, a general overview of an embodiment of the present invention will be described with reference to FIG. 2.

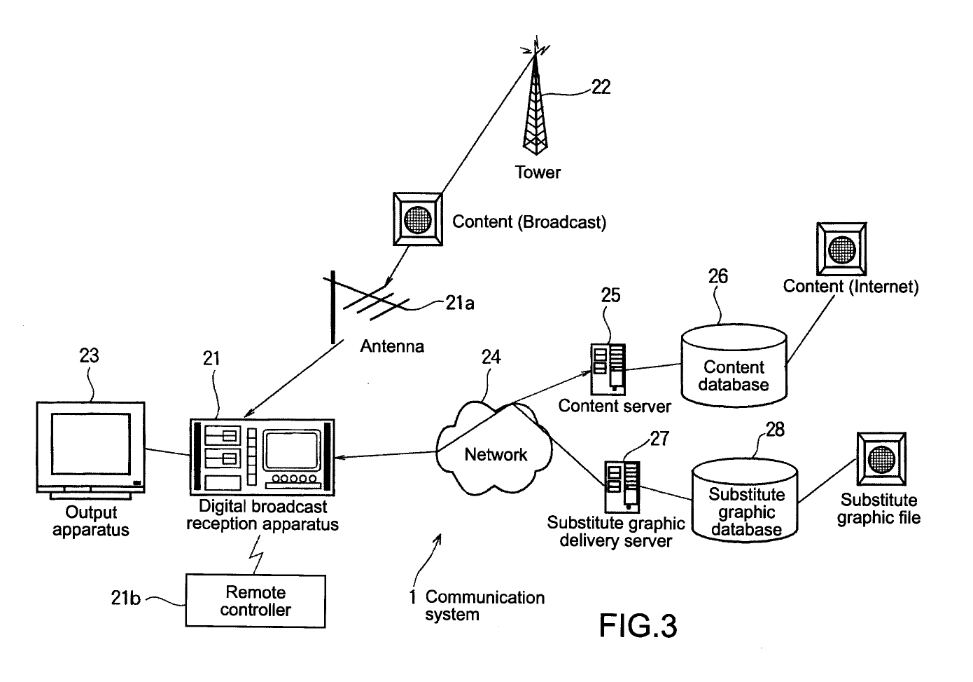

In this embodiment, when superimposing (synthesizing) a graphic on a still image having a resolution of 1920×1080 pixels, a digital broadcast reception apparatus 21 (FIG. 3) superimposes, instead of a graphic whose image quality is deteriorated due to an enlargement thereof to twice the size in a horizontal and longitudinal directions, a substitute graphic having a higher image quality than that graphic (higher resolution or higher SN (Signal to Noise) ratio) on the still image.

Specifically, for example, the digital broadcast reception apparatus 21 acquires, from a substitute graphic delivery server 27 (FIG. 3) storing (an image representing) a substitute graphic corresponding to (an image representing) a graphic to be superimposed on a still image, that is enlarged to twice the size in the horizontal and longitudinal directions, the corresponding substitute graphic. Then, the digital broadcast reception apparatus 21 draws the acquired substitute graphic on a drawing plane prepared in advance that has a resolution of 1920×1080 pixels.

Further, the digital broadcast reception apparatus 21 draws characters on the drawing plane having the resolution of 1920×1080 pixels in a character size corresponding to that drawing plane, for example.

As shown in FIG. 2, the digital broadcast reception apparatus 21 superimposes a character/graphic plane obtained by drawing the characters and graphic as described above onto a still image (moving image) representing a program or the like and outputs it to an output apparatus 23 (FIG. 3) as a data broadcast output.

It should be noted that since the digital broadcast reception apparatus 21 carries out the same processing as a digital broadcast reception apparatus of the related art in the case of synthesizing characters and graphics with a still image having a resolution of 960×540 pixels, descriptions thereof will be omitted.

### (Structural Example of Communication System 1)

Next, FIG. 3 shows a structural example of a communication system 1 including the digital broadcast reception apparatus 21 to which the present invention is applied.

The communication system 1 is constituted of an antenna 21a, the digital broadcast reception apparatus 21, a remote controller 21b, a tower 22, the output apparatus 23, a network 24, a content server 25, a content database 26, the substitute graphic delivery server 27, and a substitute graphic database 28.

The antenna 21a receives radio waves as a digital broadcast signal broadcasted from the tower 22 and supplies the acquired digital broadcast signal to the digital broadcast reception apparatus 21. The digital broadcast reception apparatus 21 receives the digital broadcast signal from the antenna 21a and outputs it to the output apparatus 23.

Further, the digital broadcast reception apparatus 21 receives a content such as a still image representing a program or the like, that is transmitted from the content server 25 via the network 24 such as the Internet and outputs the content to the output apparatus 23.

Furthermore, the digital broadcast reception apparatus 21 acquires, when the received digital broadcast signal includes a BIT (Broadcaster Information Table), URI (Uniform Resource Identifier) information as information for connecting to (accessing) the substitute graphic delivery server 27 from the BIT.

### (Example of Bit)

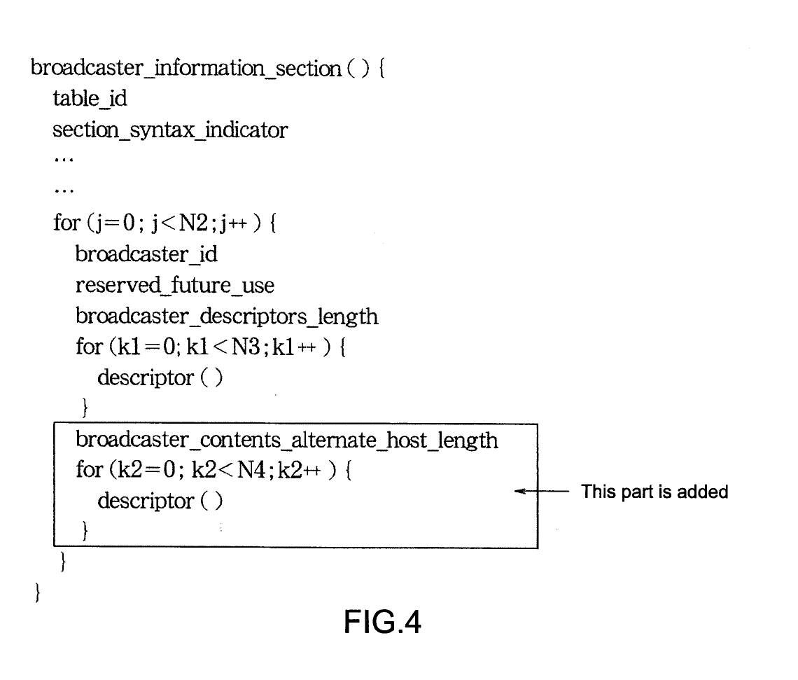

Next, FIG. 4 shows an example of a syntax of a BIT included in a digital broadcast signal.

In the BIT shown in FIG. 4, URI information (part surrounded by solid line in figure) for specifying the substitute graphic delivery server 27 is added to information described in a general BIT.

It should be noted that in the part surrounded by the solid line in the figure, broadcaster_contents_alternate_host_length indicates a length of a character string in the URI of the substitute graphic delivery server 27. Moreover, descriptor( ) described after broadcaster_contents_alternate_host_length stores a character string indicating the URI of the substitute graphic delivery server 27.

For example, the digital broadcast reception apparatus 21 is connected to the substitute graphic delivery server 27 based on the URI information described in the BIT, receives a substitute graphic from the connected substitute graphic delivery server 27, and draws the substitute graphic on a drawing plane having a resolution of 1920×1080 pixels.

Furthermore, the digital broadcast reception apparatus 21 draws characters on the drawing plane having the resolution of 1920×1080 pixels, synthesizes, with the drawing plane on which the characters have been drawn being a character/graphic plane, the character/graphic plane with a still image representing a program or the like included in the received digital broadcast signal, and outputs it to the output apparatus 23.

Referring back to FIG. 3, the remote controller 21b transmits an operation signal corresponding to a user operation to the digital broadcast reception apparatus 21.

The digital broadcast reception apparatus 21 carries out processing corresponding to the operation signal from the remote controller 21b.

The tower 22 broadcasts digital broadcast signals through radio waves.

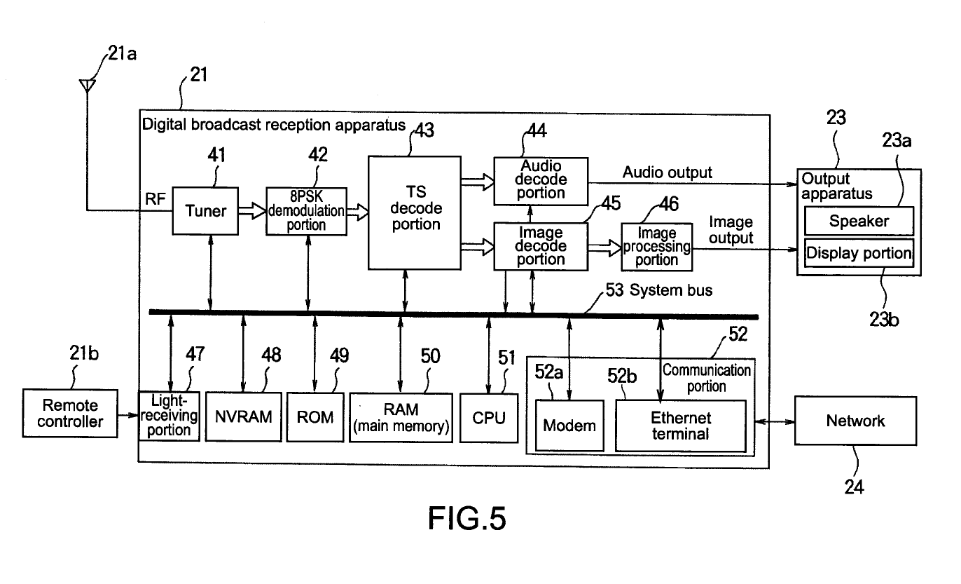

The output apparatus 23 has a built-in speaker 23a (FIG. 5) and display portion 23b (FIG. 5) such as an LCD (Liquid Crystal Display). The output apparatus 23 outputs audio corresponding to data from the digital broadcast reception apparatus 21 from the speaker 23a and displays an image corresponding to data from the digital broadcast reception apparatus 21 on the display portion 23b.

The network 24 is, for example, the Internet, and mutually connects the digital broadcast reception apparatus 21, the content server 25, and the substitute graphic delivery server 27.

The content server 25 reads out a predetermined content from the content database 26 in response to a request from the digital broadcast reception apparatus 21 and transmits the content to the digital broadcast reception apparatus 21 via the network 24.

The content database 26 stores a plurality of different contents.

The substitute graphic delivery server 27 reads out a substitute graphic file from the substitute graphic database 28 in response to a request from the digital broadcast reception apparatus 21 and supplies the file to the digital broadcast reception apparatus 21 via the network 24.

The substitute graphic database 28 stores a plurality of substitute graphic files. In each of the substitute graphic files, encoded data obtained by encoding substitute graphic data representing a substitute graphic by a predetermined encoding method is stored.

(Structural example of digital broadcast reception apparatus 21)

Next, FIG. 5 shows a detailed structural example of the digital broadcast reception apparatus 21.

The digital broadcast reception apparatus 21 includes a tuner 41, an 8PSK (Phase Shift Keying) demodulation portion 42, a TS (Transport Stream) decode portion 43, an audio decode portion 44, an image decode portion 45, an image processing portion 46, a light-receiving portion 47, an NVRAM (Nonvolatile Random Access Memory) 48, a ROM (Read-Only Memory) 49, a RAM (Random Access Memory) 50, a CPU (Central Processing Unit) 51, and a communication portion 52, all of which are connected via a system bus 53.

To the tuner 41, an RF (Radio Frequency) signal of a digital broadcast signal of a predetermined broadcast system such as a digital terrestrial broadcast and a BS (Broadcasting Satellite) digital broadcast is supplied from the antenna 21a.

The tuner 41 selects (extracts) a television signal of a predetermined channel from (the RF signal of) the digital broadcast signal of the predetermined broadcast system supplied from the antenna 21a and supplies the signal to the 8PSK demodulation portion 42.

The 8PSK demodulation portion 42 subjects the television signal of the predetermined channel supplied from the tuner 41 to an 8PSK demodulation and supplies a transport stream obtained as a result of the 8PSK demodulation to the TS decode portion 43.

The TS decode portion 43 separates a video elementary stream (video PES (Packetized Elementary Stream)) and an audio elementary stream (audio PES) from the transport stream supplied from the 8PSK demodulation portion 42.

The TS decode portion 43 also separates character data and graphic data included in the transport stream supplied from the 8PSK demodulation portion 42.

It should be noted that the character data is information on a character to be superimposed (e.g., what character is to be superimposed at what position on a still image and with what number of points the character is to be superimposed). The graphic data is information on a graphic to be superimposed (e.g., what kind of a graphic is to be superimposed at what position on a still image).

Out of the separated video PES and audio PES, the TS decode portion 43 supplies the audio PES to the audio decode portion 44 and supplies the video PES to the image decode portion 45.

Moreover, the TS decode portion 43 supplies the separated character data and graphic data to the image decode portion 45.

The audio decode portion 44 decodes the audio PES supplied from the TS decode portion 43 by a predetermined decoding method and outputs audio data obtained as a result of the decode to the speaker 23a of the output apparatus 23.

The image decode portion 45 decodes the video PES supplied from the TS decode portion 43, that have been compressed by a compression method such as an MPEG (Moving Picture Experts Group) method and supplies an image signal obtained as a result of the decode to the image processing portion 46.

Moreover, the image decode portion 45 decodes the character data and the graphic data supplied from the TS decode portion 43 by a predetermined decoding method and supplies the data to the image processing portion 46.

The image processing portion 46 generates a character/graphic plane based on the decoded character data and graphic data supplied from the image decode portion 45. Furthermore, the image processing portion 46 synthesizes the generated character/graphic plane with an image corresponding to the image signal from the image decode portion 45 and supplies the resultant to the display portion 23b of the output apparatus 23 so that the synthesized image is displayed on the display portion 23b.

The light-receiving portion 47 receives an operation signal from the remote controller 21b and supplies it to the CPU 51 via the system bus 53.

The NVRAM 48 is a nonvolatile RAM and stores programs for the CPU 51 to execute various types of processing, data instructed to be written by the CPU 51, and the like.

It should be noted that the programs stored in the NVRAM 48 can be updated by a new program supplied from the communication portion 52 via the system bus 53, and the like.

The ROM 49 stores in advance programs for the CPU 51 to execute various types of processing.

The RAM 50 temporarily stores data necessary for the CPU 51 to execute various types of processing, for example.

The CPU 51 executes the program stored in the NVRAM 48 or the ROM 49 to carry out predetermined processing. In other words, the CPU 51 controls the tuner 41, the 8PSK demodulation portion 42, the TS decode portion 43, the audio decode portion 44, the image decode portion 45, the image processing portion 46, the light-receiving portion 47, the communication portion 52, and the like.

The communication portion 52 includes a modem 52a and an Ethernet terminal 52b that function as communication interfaces with respect to the network 24.

The modem 52a is used for receiving contents, for example. The Ethernet terminal 52b is used for receiving substitute graphics, for example.

### (Description on Display Control Processing)

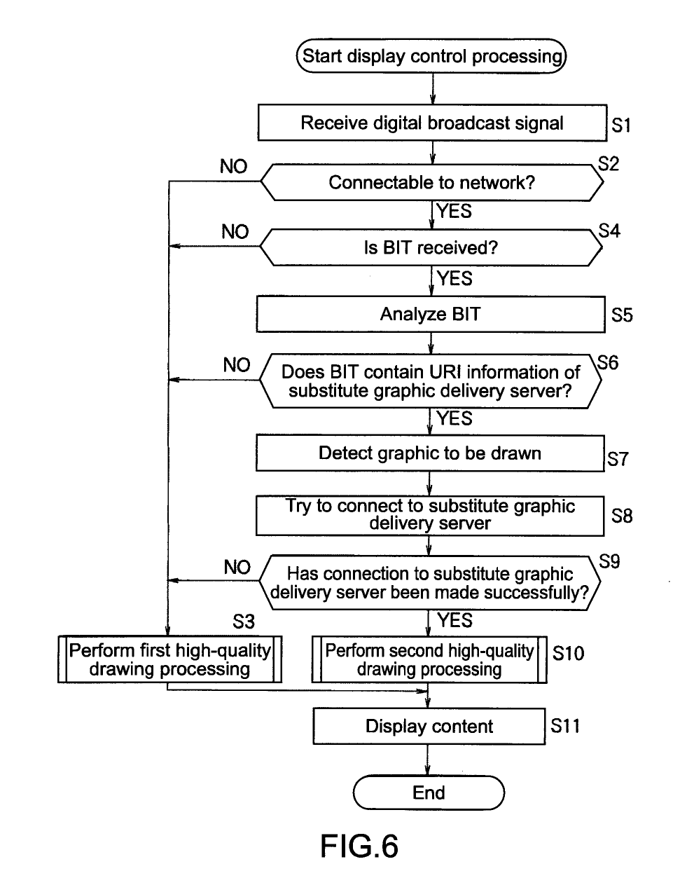

Next, referring to the flowchart of FIG. 6, display control processing carried out by the digital broadcast reception apparatus 21 for displaying an image obtained by synthesizing graphics and characters with a still image representing a program or the like will be described.

In Step S1, the tuner 41 receives a digital broadcast signal of a predetermined broadcast system supplied from the antenna 21a, selects a television signal of a predetermined channel from the received digital broadcast signal, and supplies the television signal to the 8PSK demodulation portion 42.

The 8PSK demodulation portion 42 subjects the television signal of the predetermined channel supplied from the tuner 41 to the 8PSK demodulation and supplies a transport stream obtained as a result of the 8PSK demodulation to the TS decode portion 43.

The TS decode portion 43 separates a video PES and an audio PES from the transport stream supplied from the 8PSK demodulation portion 42.

The TS decode portion 43 also separates character data and graphic data from the transport stream supplied from the 8PSK demodulation portion 42. Then, the TS decode portion 43 supplies the audio PES to the audio decode portion 44 and supplies the video PES and the character and graphic data to the image decode portion 45.

The audio decode portion 44 decodes the audio PES supplied from the TS decode portion 43 by a predetermined decoding method and outputs audio data obtained as a result of the decode to the output apparatus 23.

The image decode portion 45 decodes the video PES supplied from the TS decode portion 43 to obtain an image signal and supplies the image signal to the image processing portion 46. The image decode portion 45 also decodes the character data and the graphic data supplied from the TS decode portion 43 by a predetermined method and supplies the data to the image processing portion 46.

In Step S2, the Ethernet terminal 52b judges whether the digital broadcast reception apparatus 21 is connectable to the network 24 such as the Internet under control of the CPU 51, and when judged that the digital broadcast reception apparatus 21 is not connectable to the network 24, the process advance to Step S3.

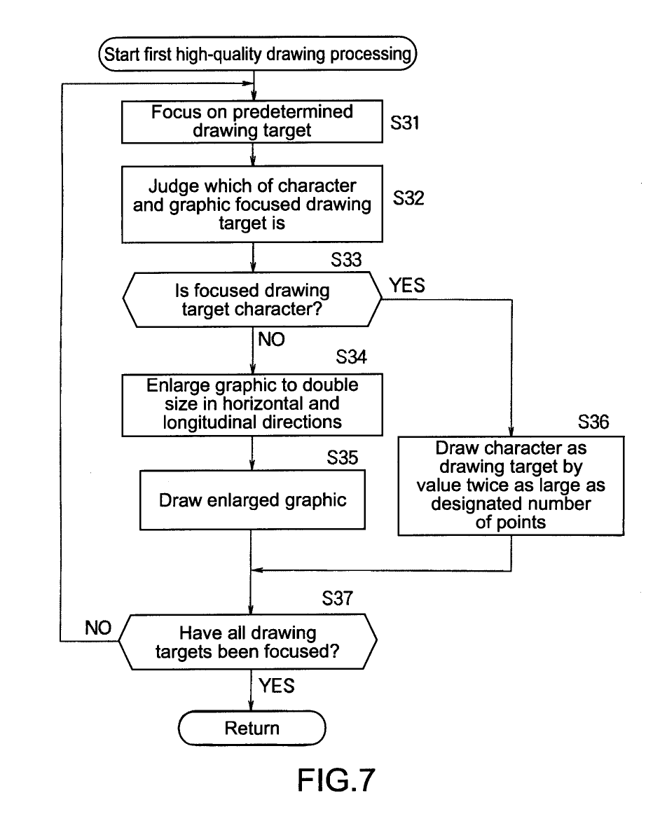

In Step S3, the image processing portion 46 carries out first high-quality drawing processing of drawing a character represented by the character data from the image decode portion 45 or a graphic represented by the graphic data from the image decode portion 45 under control of the CPU 51. It should be noted that details of the first high-quality drawing processing of Step S3 will be described later with reference to the flowchart of FIG. 7.

Further, when the Ethernet terminal 52b judges in Step S2 that the digital broadcast reception apparatus 21 is connectable to the network 24, the process advances to Step S4.

In Step S4, the tuner 41 judges whether a BIT is included in the digital broadcast signal from the antenna 21a under control of the CPU 51. When judged in Step S4 that a BIT is included, the tuner 41 extracts the BIT from the digital broadcast signal and supplies the BIT to the CPU 51 via the system bus 53.

After that, the process advances to Step S5 where the CPU 51 analyzes a content of the BIT from the tuner 41. Then, in Step S6, the CPU 51 judges whether the BIT includes URI information of the substitute graphic delivery server 27 based on the analyzed content of the BIT.

When judged in Step S6 that the BIT contains URI information of the substitute graphic delivery server 27, the CPU 51 acquires the URI information from the BIT, and the process advances to Step S7.

In Step S7, the image processing portion 46 detects a graphic represented by the graphic data from the image decode portion 45 as a graphic to be synthesized with the image corresponding to the image data from the image decode portion 45.

In Step S8, the Ethernet terminal 52b tries to connect with the substitute graphic delivery server 27 via the network 24 under control of the CPU 51. In other words, based on the acquired URI information, the CPU 51 controls the Ethernet terminal 52b to try to connect with the substitute graphic delivery server 27 via the network 24.

In Step S9, the Ethernet terminal 52b judges whether a connection to the substitute graphic delivery server 27 has successfully been made under control of the CPU 51. Then, when it is judged by the Ethernet terminal 52b that the connection has successfully been made, the process advances from Step S9 to Step S10.

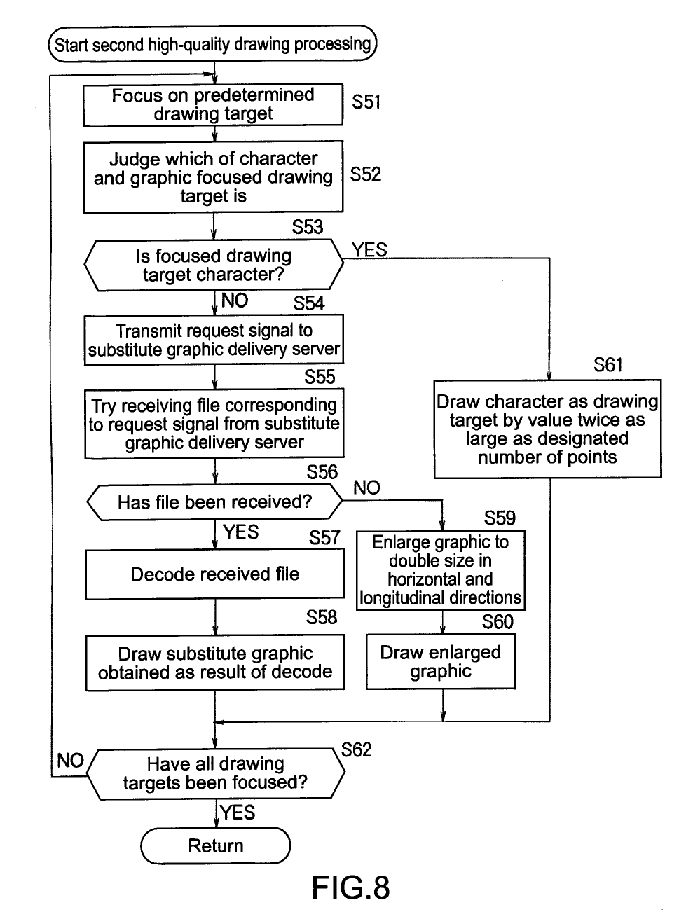

In Step S10, under control of the CPU 51, the image processing portion 46 carries out second high-quality drawing processing of acquiring desired substitute graphic data from the substitute graphic delivery server 27 and drawing a substitute graphic represented by the acquired substitute graphic data, and the like. It should be noted that details of the second high-quality drawing processing will be described later with reference to the flowchart of FIG. 8.

After the first high-quality drawing processing of Step S3 and the second high-quality drawing processing of Step S10, the process advances to Step S11.

In Step S11, under control of the CPU 51, the image processing portion 46 synthesizes (superimposes) a character/graphic plane obtained by either the first high-quality drawing processing or the second high-quality drawing processing and an image corresponding to the image data from the image decode portion 45. Furthermore, the image processing portion 46 supplies data obtained as a result of the synthesis to the output apparatus 23 so that the data is displayed thereon.

By the processes described above, the display control processing is ended.

It should be noted that when the tuner 41 judges in Step S4 that a BIT is not received since the digital broadcast signal from the antenna 21a does not include a BIT, when the CPU 51 judges in Step S6 that the BIT does not include URI information of the substitute graphic delivery server 27, and when the Ethernet terminal 52b judges in Step S9 that a connection to the substitute graphic delivery server 27 has failed, the process advances to Step S3, and the same processes are carried out thereafter.

### (Description on First High-Quality Drawing Processing)

Next, referring to the flowchart of FIG. 7, the first high-quality drawing processing of Step S3 of FIG. 6 will be described in detail.

In Step S31, the image processing portion 46 sets, based on the character data and the graphic data from the image decode portion 45, a predetermined drawing target out of drawing targets of graphics and characters to be drawn on an image corresponding to the image data from the image decode portion 45, as a focused drawing target.

In Step S32, the image processing portion 46 judges which of a character and a graphic the focused drawing target is.

Then, when the image processing portion 46 judges in Step S33 that the focused drawing target is a graphic (not character), the process advances to Step S34.

In Step S34, the image processing portion 46 enlarges the graphic represented by the graphic data from the image decode portion 45 to twice the size in the horizontal and longitudinal directions under control of the CPU 51.

Then, in Step S35, the image processing portion 46 draws the enlarged graphic on a drawing plane having a resolution of 1920×1080 pixels, and the process advances to Step S37.

When the image processing portion 46 judges in Step S33 that the focused drawing target is a character, the process advances to Step S36.

In Step S36, the image processing portion 46 draws the character as the focused drawing target on the drawing plane having the resolution of 1920×1080 pixels by the number of points newly obtained by doubling the number of points specified by the character data from the image decode portion 45. After that, the process advances from Step S36 to Step S37.

In Step S37, the image processing portion 46 judges whether all of the drawing targets have been set as the focused drawing target. Then, when the image processing portion 46 judges that not all the drawing targets have been set as the focused drawing target, the process returns to Step S31.

In Step S31, the image processing portion 46 sets, out of the drawing targets, a drawing target not yet set as the focused drawing target as a new focused drawing target, and the process advances to Step S32 to repeat the same processes thereafter.

Further, when the image processing portion 46 judges in Step S37 that all the drawing targets have been set as the focused drawing target, the drawing plane having the resolution of 1920×1080 pixels on which the character or graphic has been drawn by the process of Step S35 or S36 is used as the character/graphic plane. After that, the processing returns.

### (Description on Second High-Quality Drawing Processing)

Next, referring to the flowchart of FIG. 8, the second high-quality drawing processing of Step S10 of FIG. 6 will be described in detail.

Processes of Steps S51 and S52 are the same as those of Steps S31 and S32 of FIG. 7.

When the image processing portion 46 judges in Step S53 that a focused drawing target is a graphic (not character), the process advances to Step S54.

In Step S54, the Ethernet terminal 52b transmits, under control of the CPU 51, a request signal for requesting a substitute graphic (substitute graphic data) corresponding to the graphic as the focused drawing target to the substitute graphic delivery server 27 via the network 24.

It should be noted that the request signal contains a program ID (Identification) for identifying a program or the like represented by a still image and a graphic ID for identifying a graphic as the focused drawing target.

Moreover, the substitute graphic database 28 (FIG. 3) stores, in association with the program ID and the graphic ID, a substitute graphic file of a substitute graphic that can be substituted with a graphic identified by the graphic ID, that is used in a program identified by the program ID.

The substitute graphic delivery server 27 (FIG. 3) reads out, upon receiving the request signal from the Ethernet terminal 52b, a substitute graphic file associated with the program ID and the graphic ID contained in the request signal from the substitute graphic database 28 and transmits the file to the digital broadcast reception apparatus 21 via the network 24.

In Step S55, the Ethernet terminal 52b tries to receive the substitute graphic file transmitted from the substitute graphic delivery server 27 in response to the request signal.

In Step S56, the Ethernet terminal 52b judges whether the substitute graphic file has been received within a predetermined time period. When judged in Step S56 that the substitute graphic file has been received within the predetermined time period, the Ethernet terminal 52b supplies the received substitute graphic file to the image decode portion 45 via the system bus 53, and the process advances to Step S57.

In Step S57, the image decode portion 45 decodes (encoded data stored in) the substitute graphic file supplied from the Ethernet terminal 52b via the system bus 53 to acquire a substitute graphic corresponding to the graphic as the focused drawing target. Then, the image decode portion 45 supplies the acquired substitute graphic to the image processing portion 46.

In Step S58, the image processing portion 46 draws the substitute graphic from the image decode portion 45 on the drawing plane having the resolution of 1920×1080 pixels, and the process advances to Step S62.

When the Ethernet terminal 52b judges in Step S56 that the substitute graphic file has not been received within the predetermined time period, the process advances to Step S59.

In Steps S59 and S60, processes that are the same as those of Steps S34 and S35 of FIG. 7 are carried out, and the process advances to Step S62.

When the image processing portion 46 judges in Step S53 that the focused drawing target is a character, the process advances to Step S61. Then, in Step S61, a process that is the same as that of Step S36 of FIG. 7 is carried out, and the process advances to Step S62.

In Step S62, the image processing portion 46 judges whether all the drawing targets have been set as the focused drawing target. Then, when the image processing portion 46 judges that not all the drawing targets have been set as the focused drawing target, the process returns to Step S51.

In Step S51, the image processing portion 46 sets a drawing target not yet set as the focused drawing target out of the drawing targets as a new focused drawing target, and the process advances to Step S52 to repeat the same processes thereafter.

Moreover, when the image processing portion 46 judges in Step S62 that all the drawing targets have been set as the focused drawing target, the drawing plane on which drawing has been made by the process of Step S58, S60, or S61 is used as the character/graphic plane, and the processing returns.

As described above, in the display control processing, a substitute graphic is acquired from the substitute graphic delivery server 27 when the digital broadcast reception apparatus 21 is connectable to the substitute graphic delivery server 27, the acquired substitute graphic is drawn on the drawing plane having the resolution of 1920×1080 pixels instead of a graphic contained in the digital broadcast signal, and a character/graphic plane obtained as a result of the drawing is synthesized with an image corresponding to image data.

Therefore, as compared to a digital broadcast reception apparatus of the related art in which a character/graphic plane obtained by enlarging a drawing plane that has a resolution of 960×540 pixels and on which a graphic has been drawn to twice the size in the horizontal and longitudinal directions is synthesized with an image corresponding to image data, for example, a graphic of a higher image quality can be synthesized with an image corresponding to image data.

Incidentally, as a method of improving an image quality of a graphic to be synthesized with an image corresponding to image data, there is, for example, a method of incorporating a high-quality graphic into a digital broadcast signal to be broadcasted on a broadcast station side such as the tower 22, and receiving an displaying the high-quality graphic on the digital broadcast reception apparatus side.

When adopting this method, however, it is difficult to display the graphic in the digital broadcast reception apparatus of the related art.

As another method of improving an image quality of a graphic to be synthesized with an image corresponding to image data, there is a method of broadcasting both a graphic that can be displayed on the digital broadcast reception apparatus of the related art and a graphic having a higher image quality than that graphic by a digital broadcast signal.

In this case, however, since both the graphic that can be displayed on the digital broadcast reception apparatus of the related art and the graphic having a higher image quality than that graphic are broadcasted by a digital broadcast signal, there is a fear that a band frequency allocated to digital broadcast signals may be oppressed.

On the other hand, in this embodiment, since an alteration such as incorporating a high-quality graphic into a digital broadcast signal is not carried out on a broadcast station side, it is possible to display a graphic included in the digital broadcast signal and the like without oppressing a band frequency allocated to digital broadcast signals.

### 2. Modified Example

In the above embodiment, the digital broadcast reception apparatus 21 has acquired URI information of the substitute graphic delivery server 27 from a BIT. However, the method of acquiring URI information is not limited thereto.

Specifically, for example, it is possible to describe URI information of the substitute graphic delivery server 27 in another information different from a BIT, that is included in a digital broadcast signal, so that the digital broadcast reception apparatus 21 can acquire the URI information from that information different from the BIT.

Moreover, it is also possible to store URI information in a predetermined server connected via the network 24 so that the digital broadcast reception apparatus 21 can acquire URI information from the predetermined server, for example.

Alternatively, URI information may be stored in advance in the digital broadcast reception apparatus 21, for example.

Furthermore, although the digital broadcast reception apparatus 21 has synthesized a character and a substitute graphic with a still image representing a program or the like included in a digital broadcast signal in the above embodiment, a character and a substitute graphic can similarly be synthesized with a still image representing a program or the like from the content server 25 (content).

Although the content server 25 and the substitute graphic delivery server 27 have been structured as separate servers in the above embodiment, it is also possible to adopt, for example, in place of the content server 25 and the substitute graphic delivery server 27, a server that has both functions as the content server 25 and the substitute graphic delivery server 27.

Moreover, although the Ethernet terminal 52b has been used for receiving substitute graphics in the above embodiment, it is also possible to use the modem 52a together with or in place of the Ethernet terminal 52b, for receiving substitute graphics.

It should be noted that in the specification, the steps describing the display control processing, the first high-quality drawing processing, and the second high-quality drawing processing include, in addition to the processes that are carried out in time series in the stated order, processes that are not necessarily carried out in time series and executed in parallel or individually.

Further, in the specification, the system represents an entire apparatus constituted of a plurality of apparatuses.

The present application contains subject matter related to that disclosed in Japanese Priority Patent Application JP 2009-036713 filed in the Japan Patent Office on Feb. 19, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A reception apparatus receiving reception data including at least image data representing a predetermined image and graphic data representing a first graphic that is enlarged by a predetermined enlargement factor to be synthesized with the predetermined image, the reception apparatus comprising:
an acquisition means for acquiring server access information for connecting to a delivery server that delivers high-quality graphic data representing, instead of the first graphic enlarged by the predetermined enlargement factor, a second graphic that is to be synthesized with the predetermined image and has a higher image quality than the enlarged first graphic;
a reception means for receiving the high-quality graphic data from the delivery server based on the server access information; and
a synthesis means for synthesizing the second graphic with the predetermined image based on the high-quality graphic data and the image data.

2. The reception apparatus according to claim 1,
wherein the reception data is a digital broadcast signal including the server access information in addition to the graphic data and the image data, and
wherein the acquisition means acquires the server access information from the digital broadcast signal.

3. The reception apparatus according to claim 2,
wherein the synthesis means synthesizes, when the high-quality graphic data is not received by the reception means, the first graphic enlarged by the predetermined enlargement factor with the predetermined image based on the graphic data and the image data included in the digital broadcast signal.

4. The reception apparatus according to claim 2,
wherein the digital broadcast signal also includes character data representing a character to be synthesized with the predetermined image, and
wherein the synthesis means additionally synthesizes, with the predetermined image, the character of a size corresponding to the predetermined image based on the character data.

5. The reception apparatus according to claim 1,
wherein the acquisition means acquires the server access information for connecting to the delivery server that delivers the high-quality graphic data representing the second graphic having a higher resolution than the enlarged first graphic.

6. The reception apparatus according to claim 1,
wherein the synthesis means draws, based on the high-quality graphic data, the second graphic on a drawing plane to be synthesized with the predetermined image, and synthesizes the drawing plane on which the second graphic has been drawn with the predetermined image.

7. A reception method for a reception apparatus that receives reception data including at least image data representing a predetermined image and graphic data representing a first graphic that is enlarged by a predetermined enlargement factor to be synthesized with the predetermined image, the reception apparatus including an acquisition means, a reception means, and a synthesis means, the reception method comprising the steps of:
acquiring, by the acquisition means, server access information for connecting to a delivery server that delivers high-quality graphic data representing, instead of the first graphic enlarged by the predetermined enlargement factor, a second graphic that is to be synthesized with the predetermined image and has a higher image quality than the enlarged first graphic;
receiving, by the reception means, the high-quality graphic data from the delivery server based on the server access information; and
synthesizing, by the synthesis means, the second graphic with the predetermined image based on the high-quality graphic data and the image data.

8. A program causing a computer of a reception apparatus that receives reception data including at least image data representing a predetermined image and graphic data representing a first graphic that is enlarged by a predetermined enlargement factor to be synthesized with the predetermined image to function as:
an acquisition means for acquiring server access information for connecting to a delivery server that delivers high-quality graphic data representing, instead of the first graphic enlarged by the predetermined enlargement factor, a second graphic that is to be synthesized with the predetermined image and has a higher image quality than the enlarged first graphic;
a reception means for receiving the high-quality graphic data from the delivery server based on the server access information; and
a synthesis means for synthesizing the second graphic with the predetermined image based on the high-quality graphic data and the image data.

9. A communication system, comprising:
a reception apparatus to receive reception data including at least image data representing a predetermined image and graphic data representing a first graphic that is enlarged by a predetermined enlargement factor to be synthesized with the predetermined image; and
a delivery server to deliver high-quality graphic data representing a second graphic that has a higher image quality than the first graphic enlarged by the predetermined enlargement factor in response to a request signal from the reception apparatus,
the reception apparatus including
an acquisition means for acquiring server access information for connecting to the delivery server that delivers the high-quality graphic data representing, instead of the first graphic enlarged by the predetermined enlargement factor, the second graphic that is to be synthesized with the predetermined image and has a higher image quality than the enlarged first graphic,
a first reception means for receiving the high-quality graphic data from the delivery server based on the server access information, and
a synthesis means for synthesizing the second graphic with the predetermined image based on the high-quality graphic data and the image data,
the delivery server including
a second reception means for receiving the request signal that requests transmission of the high-quality graphic data transmitted from the reception apparatus based on the server access information, and
a transmission means for transmitting the high-quality graphic data to the reception apparatus based on the request signal.

10. A reception apparatus receiving reception data including at least image data representing a predetermined image and graphic data representing a first graphic that is enlarged by a predetermined enlargement factor to be synthesized with the predetermined image, the reception apparatus comprising:
an acquisition portion to acquire server access information for connecting to a delivery server that delivers high-quality graphic data representing, instead of the first graphic enlarged by the predetermined enlargement factor, a second graphic that is to be synthesized with the predetermined image and has a higher image quality than the enlarged first graphic;
a reception portion to receive the high-quality graphic data from the delivery server based on the server access information; and
a synthesis portion to synthesize the second graphic with the predetermined image based on the high-quality graphic data and the image data.

11. A program causing a computer of a reception apparatus that receives reception data including at least image data representing a predetermined image and graphic data representing a first graphic that is enlarged by a predetermined enlargement factor to be synthesized with the predetermined image to function as:
an acquisition portion to acquire server access information for connecting to a delivery server that delivers high-quality graphic data representing, instead of the first graphic enlarged by the predetermined enlargement factor, a second graphic that is to be synthesized with the predetermined image and has a higher image quality than the enlarged first graphic;
a reception portion to receive the high-quality graphic data from the delivery server based on the server access information; and
a synthesis portion to synthesize the second graphic with the predetermined image based on the high-quality graphic data and the image data.
